(19) United States
(12) Patent Application Publication
(10) Pub. No.: US 2009/0320696 A1
(43) Pub. Date: Dec. 31, 2009

(54) DEVICE FOR PROCESSING FOODSTUFFS

(76) Inventor: Bruno Herren, Beckenried (CH)

Correspondence Address: OSTROLENK FABER GERB & SOFFEN, 1180 AVENUE OF THE AMERICAS, NEW YORK, NY, 100368403, US

(21) Appl. No.: 12/299,451

(22) PCT Filed: May 3, 2007
(86) PCT No.: PCT/CH2007/000219

§ 371 Date: Apr. 3, 2009

(30) Foreign Application Priority Data
May 4, 2006 (CH) 730/06
Jan. 22, 2007 (CH) 90/07

(51) Int. Cl. B02C 25/00; B02C 23/00

(52) U.S. Cl. 99/493; 241/101.3

(57) ABSTRACT

A device for processing foodstuffs in accordance with an embodiment of the present disclosure includes an upper part, a drive mechanism and a lower part with a working container. In said device, a working unit can be manually driven and made to rotate by means of a drive mechanism and the working unit, in addition, includes a working rate indicator. The indicator preferably includes light-emitting diodes, which provide the user with information about the progress of the work to be completed. The working rate indicator is electrically/electronically driven and the energy required for this is produced by a generator.

### FIELD OF THE INVENTION

Manually operated devices for processing, in particular comminuting vegetables and other foodstuffs have been known for years. A device with a crank drive, in which two rigid blades, which project in opposite directions at right angles, are arranged on a central shaft which projects perpendicularly into an approximately circular-cylindrical container for cut material, is described in U.S. Pat. No. 6,035,771. After the material to be comminuted has been filled into the container, the latter is placed on a work surface and the top part with the crank drive is placed on it. In use, i.e. in particular when turning the crank, the device must be held in place with the second hand, or respectively pressed against the work surface. When operating the device, the user does not receive any information regarding the progress of the work. The degree of comminution of the foodstuffs to be processed can only be detected by removing the top part and looking directly into the container for material to be processed. It is not possible to judge from the outside whether still further revolutions of the crank are necessary.

A small, approximately cylindrical manually operated device is known from WO 2004/073474, which is hand-held for operation. A central shaft with two blades, which project at right angles in opposite directions, is driven by means of the repeated rotation of a circular drive mechanism in relation to the coaxially arranged container with the material to be processed. Since the device must be almost completely enclosed by the hands of the user, the structural size is extremely limited. The material to be processed—for example an onion—must be cut into quarters for filling, since otherwise there is no room for it in the container for the material to be processed. For achieving a satisfactory chopping result, it is necessary to rotate the drive element 40 to 60 times alternatingly in opposite directions in relation to the remaining parts of the device. The rotating movement of the drive unit in relation to the container is transmitted by a gear to the shaft with the cutters. Since the blades are provided with cutting edges on both sides, it is possible to cut in both directions by a directed reversal of the turning direction of the shaft. Even though the device has a container made of a transparent material and should therefore allow a view of the interior, i.e. of the material to be processed, in actual use it has been shown that in the course of, or after, the cutting operation no clear view of the interior is possible. If fresh vegetables or herbs are cut, the entire container is smudged by juice within a short time, so that no conclusion regarding the degree of cutting is possible anymore from the outside. The user must again open the device and check the work process directly in the container.

Other devices for processing vegetables and the like, which have an electrical drive mechanism and various control programs, are known. For example, US 2002/0176320 shows a mixer, which has predefined programs for motor control, which are shown on a display. Thus, the user is provided with the possibility of pre-selecting a suitable program in accordance with the material to be processed. After the start of the selected program the respective control commands are executed and the motor drives the cutting unit, and the time, direction and number of revolutions of the rotating movement are preprogrammed. No report regarding the result of cutting is provided. Therefore the user has no possibility of terminating the microprocessor-controlled program when a desired degree of cutting has been reached. Moreover, in connection with such devices the dependence on external energy sources is disadvantageous, as well as the required electrical cord for energy supply which, on the one hand, limits the work location and, on the other, unnecessarily requires work space.

### BACKGROUND OF THE INVENTION

The object of the invention is based on making available a device in accordance with the invention which does not have the above mentioned disadvantages. It is intended to show a device which permits the control of the processing degree without being dependent on either an external energy supply or batteries or the like. Furthermore, manufacture and assembly of the device should be cost-efficient and, besides cutting or chopping, the device should be usable for further processing steps of foodstuffs, and in general should be simple, dependable and comfortable to operate and to clean.

This object is attained by means of a device having the characteristics of claim 1.

Further advantageous embodiments of the device in accordance with the invention ensue from the dependent claims.

It is an essential characteristic of the device in accordance with the invention that a processing degree indicator directly shows the user the actual work progress by means of an easily visible display. The processing degree indicator is autonomous, i.e. independent from an external voltage supply wherein, in accordance with preferred embodiments, a generator unit internal to the device sees to it that no batteries or similar voltage sources are required.

It is essential for understanding the invention that in connection with the novel devices no previously stored program is executed, instead the actually performed number of processing movements, i.e. for example the actually performed number of revolutions of the drive unit and/or the processing unit, is detected and displayed. This direct reporting, together with the manual drive method, makes it possible for the user to stop the work process at any time, or to continue it.

The user is provided with information regarding the work progress, for example the degree of comminution achieved, without having to open the device for this or to make a direct check of the material to be processed in the processing container.

### BRIEF DESCRIPTION OF THE DRAWINGS

The invention will be explained in what follows by means of drawing figures which merely represent exemplary embodiments. Shown are in:

FIG. 1, a longitudinal sectional view along the central axis in a plane A-A through the device in accordance with a first embodiment with a drive mechanism with a gear and a directly driven generator, in which a cutting unit is not represented in section,

FIG. 2, a section through a top part of a device in accordance with FIG. 1 along B-B,

FIG. 3 a detailed plan view of the section in accordance with FIG. 2 with a generator unit in accordance with an embodiment,

FIG. 4, a view from above on a cover of a device in accordance with FIG. 1,

FIG. 5, a general functional sketch of a generator unit in accordance with the first embodiment in a view from above,

FIG. 6, a lateral plan view of the sketch in accordance with FIG. 5,

FIG. 7, a longitudinal section along the central shaft through the device in accordance with a second embodiment with direct drive and generator in frictional connection, in which a cutting unit is not represented in a sectional view, and

FIG. 8, a view from above on a top part in accordance with FIG. 7, in which the cover is not drawn in.

### DETAILED DESCRIPTION OF THE PREFERRED EMBODIMENTS

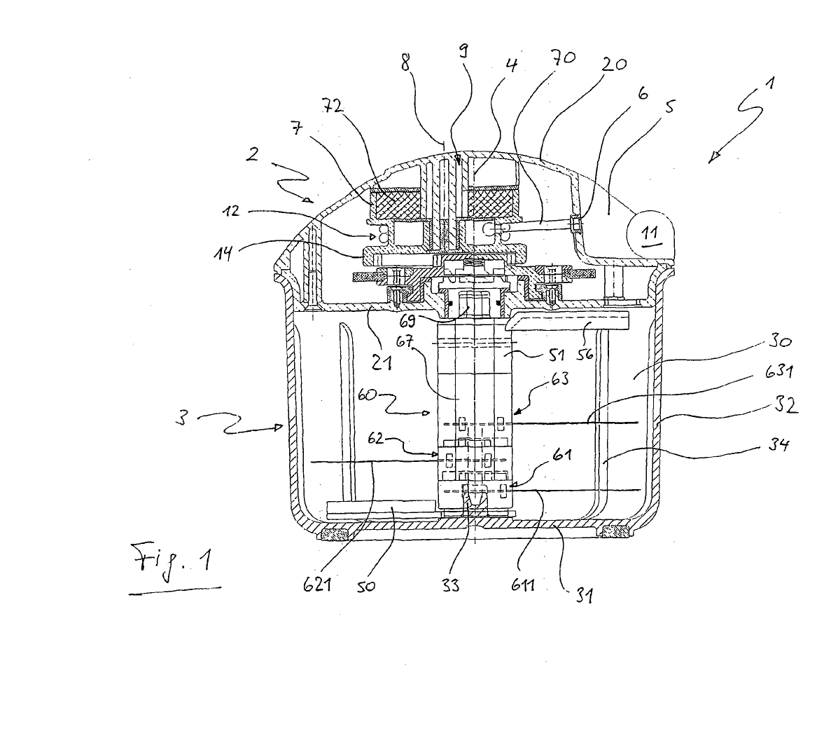

A first embodiment of the device 1 for processing foodstuffs in accordance with the invention is represented in axial longitudinal section in FIG. 1. The represented device is a cutting device and is comprised of a cutting unit 60, which is not shown in section. The device 1, which is embodied substantially rotation-symmetrical around a central shaft 4, has a top part 2, which is comprised of a circular, substantially flat base 21 with a curved cover 20 placed on it. Essential parts of a drive mechanism 10, as well as a device for displaying the processing degree, called processing degree indicator in what follows, are housed between the cover 20 and the base 21. The top part 2 can be placed in a positive and/or non-positive manner on a lower part 3 which, in the present case, comprises a bowl-shaped container 30 for material to be cut. The container 30 for material to be cut is preferably made of a transparent or semi-transparent plastic material approved for foodstuffs and includes a bottom 31 with a central, upward oriented bearing journal 33 and a lateral wall 32 with a plurality of vertical swirling ribs 34, evenly distributed over the circumference. On its underside the cutting unit 60 is provided with a central bearing opening, by means of which it can be plugged onto the bearing journal 33 in the container 30 for material to be cut. The cutting unit 60 in accordance with the represented embodiment is substantially constituted by a cutter shaft 67, from which three blades 61, 62, 63 and two deflectors 50, 51 protrude as the operative means. A drive cam 69 at the top, in the exemplary embodiment represented a cam with a hexagonal exterior, of the cutting unit 60 engages a corresponding reception opening 71 of an engagement member 23 of the drive mechanism 10 in a positive manner, so that the torque can be transferred from the engagement member 23 of the drive mechanism 10 to the cutting unit. The engaging member 23 is seated in the center of the base 21 rotatably, but not axially displaceable, with low friction and sealed against the base 21. In this way the cutter shaft 67 with the operative means 50, 51, 61, 62, 63 is dependably seated at the top and the bottom, and during the operation can absorb without problems the forces introduced into the operative means, in the present example the cutters 61, 62, 63 and the deflectors 50, 51, even at high rpm, without being deflected out of their axial position.

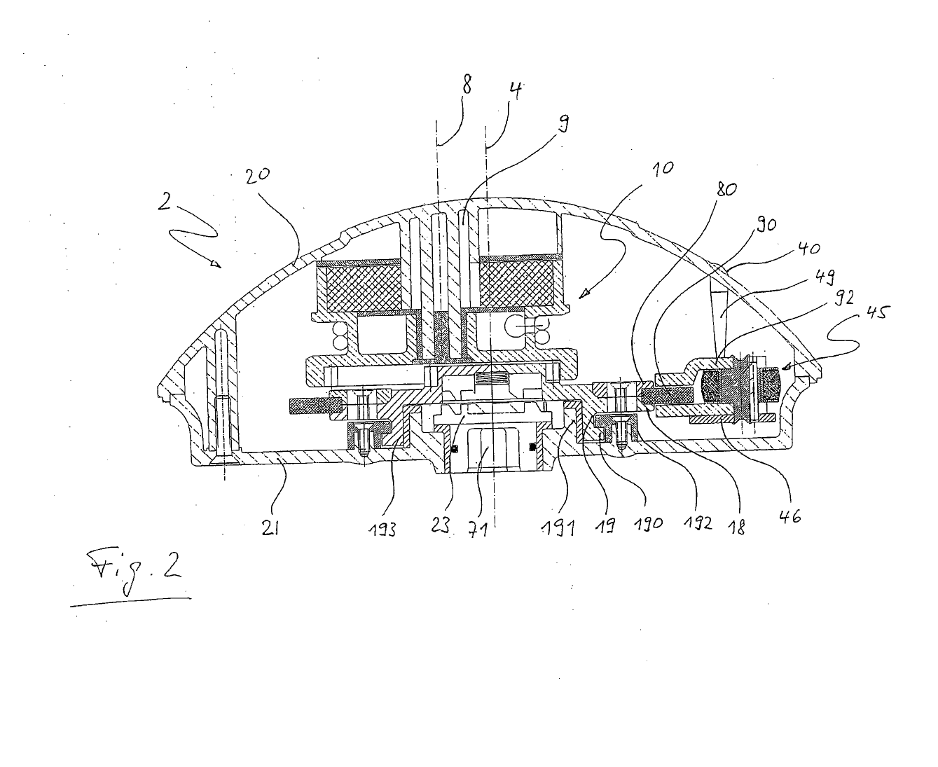

In accordance with the instant invention, the rotating movement of the operative means is generated by a cord pull mechanism. As represented in FIGS. 1 and 2, with the pull cord 70 wound up, the handle 11 comes to rest in a recess 5 of the cover 20. The pull cord 70 fastened to it is conducted under low friction to a winder or cord roller 12 attached to the interior of the top part 2 and is wound up on it. A spring housing 7 is arranged concentrically above the winder 12 on a bearing journal 9, which extends downward from the cover 20. The length of the cord pull 70 has been selected to be 400 to 750 mm, preferably 600 mm, in such a way that, with a corresponding diameter of the winder 12, the winder 12 rotates over the entire diameter 3 to 6 times, preferably 4 to 5 times, per pull on the pull cord 70 (until its complete unwinding). In the exemplary embodiment of FIGS. 1 and 2, a device 1 with a drive mechanism 10 with gearing is represented, in which the driveshaft 8 is arranged eccentrically on the inside of the cover.

The winder 12 is preferably manufactured in one piece with the spring housing 7 located above it and a hollow wheel, also called drive wheel 14, located below it. The drive wheel 14, arranged eccentrically in relation to the central shaft 4, is open at the bottom and provided with internal teeth. The internal teeth are respectively only sketched in FIGS. 1 and 2. It is in an operative connection with external teeth of an axial journal 17, which is seated concentrically in respect to the central shaft 4 in the top part 2. The gear ratio in the exemplary embodiment represented is 1:1.8, while a gear ratio of 1:1.5 up to 1:4 has proven itself to be advantageous.

The axial journal 17 is a part of a secondary drive unit, comprised of the axial journal 17, rotor disk 18 and bearing bushing 19, and whose axis of rotation coincides with the central shaft 4 of the device 1. The axial journal 17 is concentrically seated on a rotor disk 18, which has clamping means for receiving a magnetic ring 90. In the exemplary embodiment represented, the clamping means have a peripheral groove. An interior area of the magnetic ring is clampingly held in the peripheral groove of the rotor disk 18 by means of a clamping ring 80, so that the larger portion of the magnetic ring diameter freely projects outward in the radial direction. The magnetic ring 90 is part of a generator unit of the processing degree indicator and will be described in greater detail in what follows.

A cylindrical bearing bushing 19 projects downwardly from the underside of the rotor disk 18 and is provided with a lower flange 190 extending around the outside. By means of the bearing bushing 19 the secondary drive unit is seated on an axial cylinder 191 of the base 21. A plurality of hold-down devices 192, distributed around the outer circumference of the bearing bushing 19 and screwed together with the base 21, extend behind the flange 190 and assure, without hampering its rotatability, that the secondary drive unit cannot be released from the axial cylinder 191 in the axial direction. As represented in FIGS. 1 and 2, a bearing sleeve 193 has been preferably pressed or glued on the axial cylinder 191, which gives the structure greater stability and reduces wear. Greatly stressed areas of the driveshaft 8 and the central bearing opening of the base 21 of the top part 2 are provided with appropriate bearing sleeves in the same way.

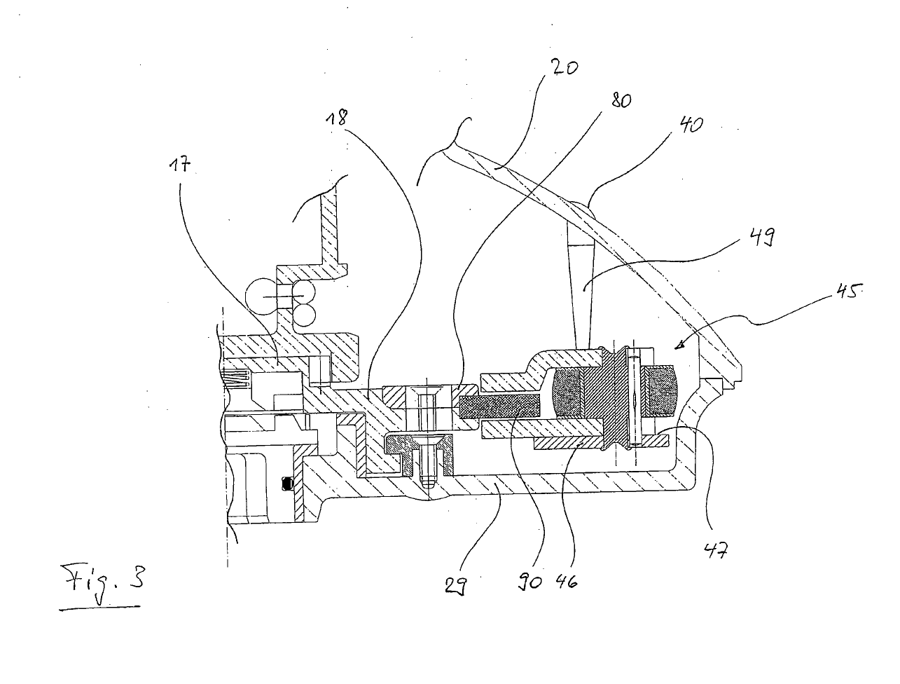

FIG. 3 now shows a longitudinal section through the top part 2 of the device 1 along the central shaft 4 and the generator axis. The magnetic ring 90, which is clampingly maintained on a rotor ring 18 by means of the clamping ring 80, passes through the stator 92. On the side facing away from the magnetic ring 90, the stator 92 is surrounded by a coil body 91. A base plate 46 not only supports the stator 92 with the coil and magnetic ring 90, but also an electronic unit, not visible in the sectional representation. The electronic unit 47 substantially includes a rectifier, a capacitor, a counter and illuminating means, particularly preferred in the form of light-emitting diodes 48. At least one optical wave guide 49 provides the operative connection between the light-emitting diodes 48 and a display unit 40 arranged in the cover. Employment of the at least one optical wave guide permits the placement of the illuminating means directly on the base plate 46, instead of in the display unit 40 in the cover 20, which considerably lowers manufacturing costs. All electrical contacts for the illuminating means can be arranged on the base plate, and the optical wave guides make cable connections to the display unit in the cover unnecessary. The display unit 40 arranged at an upper end of the optical wave guide can be attached as a separate piece in a suitable perforation in the cover 20, or can be embodied in one piece with the optical wave guide. The optical wave guide and the display unit have been preferably produced by means of an extrusion process from a suitable transparent light-conducting plastic material.

The generator 45 supplies the electronic unit 47 with electrical current. As also mentioned, the electronic unit 47 is arranged, together with the generator 45, preferably on the base plate 46, which can be fastened on the bottom 29 of the base plate 21, for example by means of nipples. This modular construction permits the production of simpler embodiments of the device without a processing degree indicator, wherein the base plate 46 with the generator 45 and the electronic unit 47 is simply omitted during production and, depending on the embodiment form of the cover 20, the reception opening for the display unit 40 is closed off with a suitable insert. In connection with such a simple model, the magnetic ring 90 and the clamping ring 80 have also been correspondingly omitted. But the remaining components of both devices can be produced with the same extrusion molds, which has an extremely advantageous effect on production costs.

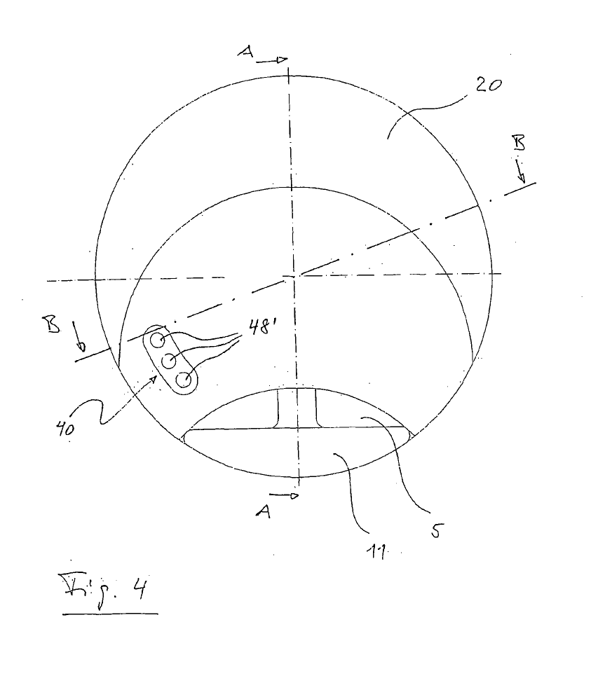

The electronic unit 47 and the display unit 40 are components of the processing degree indicator which, in accordance with the present invention, makes it possible also for untrained users to obtain cut material of an ideal cutting degree. The display unit 40 is arranged in the cover 20, as shown in FIG. 4, for example, and can be easily viewed by the user. The position at the side of the cutout for the handle 11 has shown itself to be advantageous, in particular for right-handed people, since in two-handed use it remains facing the user and is not covered by the hand of the user with which the device is held. The processing degree indicator, in particular its display unit 40, is advantageously constructed in a very simple manner and can be intuitively understood by the user without further instruction. Accordingly, in the exemplary embodiment in FIG. 4, a display unit 40 for three light-emitting diodes 48 has been inserted, easily visible to the user, into the cover 20. The three LED's, for example in the colors green, yellow and red, are arranged on the base plate 46. In the exemplary embodiment represented, the light from the three LEDs is conducted via the optical wave guide to the display unit in such a way, that there three light spots 48′ can be generated in a row next to each other. In this case a light spot 48′ is assigned to each LED. It is obvious to one skilled in the art that the employment of optical wave guides in accordance with the instant invention permits an enormous constructive variety of the display unit. For example, these can be designed in the form of letters, numbers, symbols and/or pictograms, wherein each display unit is comprised of one or several of such display elements. By means of only one light-emitting diode it is also possible to illuminate several display units, or several display elements within a display unit. However, a display unit 40 for only one light-emitting diode 48 is also possible, in which the light-emitting diode 48 changes colors by being appropriately triggered.

In what follows, a functional example of the processing degree indicator in accordance with the invention will be described by means of the exemplary embodiment of FIG. 4, in which the degree of fineness of foodstuffs to be cut, for example of onions or other vegetables, is indicated to the user. For registering the number of revolutions of the processing unit, i.e. the cutting unit 60, and therefore of the blades 611, 621, 631, during the operation of the device, the number of revolutions of the rotor disk 18 is preferably detected by the electronic device and is intermediately stored. In the exemplary embodiment represented, the length of the pull cord has been selected to be 600 mm so that, with a corresponding diameter of the winder and corresponding gearing, the cutting unit rotates ten times over the entire circumference per pull on the pull cord (up to its complete unwinding). As soon as the intermediately stored value lies above a preset value (of 70 full revolutions of the rotor disk, for example), the green LED of the display is illuminated or blinks. By this it is indicated to the user that, although the material to be cut has been evenly comminuted, it is still rather coarse. The green LED is illuminated or blinks, preferably fed by a capacitor, as long as the cumulative number of revolutions lies below the preselected value of 150. The cutting unit 60, as well as the rotor disk, are further rotated by further pulls on the cord pull and, after exceeding the threshold value of 150 revolutions, the display changes from green to yellow, i.e. the yellow LED is triggered and the green one switched off. In this way a signal is provided to the user that now the material to be cut is finely cut and, after approximately 100 further revolutions, the display changes into the red range, i.e. the red LED is illuminated or blinks instead of the yellow one. In this way the user is provided with the information that the material to be cut is now present in a very finely comminuted way and further processing would only result in finely pureed cut material. In accordance with a preferred embodiment, the green LED is active from 70 revolutions (corresponding to 7 pulls of the pull cord), the yellow one between 71 and 150, and the red one starting at 250. Since the revolutions of the rotor disk are being measured, it makes no difference whether the cord is respectively unwound completely or only partially, in any case the actual number of revolutions of the cutting means is detected and displayed.

It is alternatively also possible to select the sequence yellow, green and red of the LED colors, so that still rough material to be cut is signaled by yellow color to the user, finer material to be cut by the green LED and very fine cut material, or puree, by red light. In a further form of embodiment, a low-consumption LCD display is provided in place of the LEDs, in which the increasing fineness of the material to be cut, or further processing progress, is symbolized by increasing bars, for example.

In place of the above described display categories, which can rather be combined under the term of graphic display categories (green, yellow, red signals, or bar graphics), it is possible to represent the actually detected number of revolutions of the processing means on a suitable alpha-numeric display. This can be by itself, or be in combination with the previously described graphic displays.

In accordance with a preferred embodiment, the measurement of the number of revolutions takes place by the counting of the voltage changes in the counting device prior to the ac-voltage being changed into a dc-voltage in the rectifier. However, it is also conceivable to count the visual detection of a marker, for example on the rotor disk, a magnetic marker, or even the passage through an electrical contact.

Since it is often not desired to provide the device for foodstuff processing with a battery, the electrical current required for operating the electronic processing degree indicator is preferably generated by the above mentioned generator 45, which is operated by means of the rotating movement during cutting or processing. The voltage provided by the generator 45 is rectified and is used for charging a storage capacitor. The downstream connected electronic unit 47 and the light-emitting diodes 48 are provided with energy from this storage capacitor. The electrical current consumption by the electronic unit 47 and the LEDs is so low that the user practically does not notice the mechanical resistance generated by the generator 45. To further reduce the electrical current consumption, it is possible to operate the LEDs in a blinking mode. In order to be able to omit additional operating elements and components connected therewith, in accordance with a preferred embodiment the electronic unit 47 switches off the display a few seconds after the stop of the drive mechanism 10 and returns the internal counter to zero.

After the desired degree of fineness has been reached, the user stops and the cord 70 is rewound by means of the pre-wound restoring spring 72 until the handle 11 comes to rest in the recess 5 provided on the cover 20. The top part 2 can be removed from the container 30 for the material to be cut, and the finished material can be removed or stored in the container. The user is always informed of the processing progress by the display unit arranged on the top of the device and need not open the device for checking. A table is made available to untrained users which indicates the degree of fineness which has been achieved in the respectively displayed category in connection with vegetables, fruits and/or herbs often used in the kitchen.

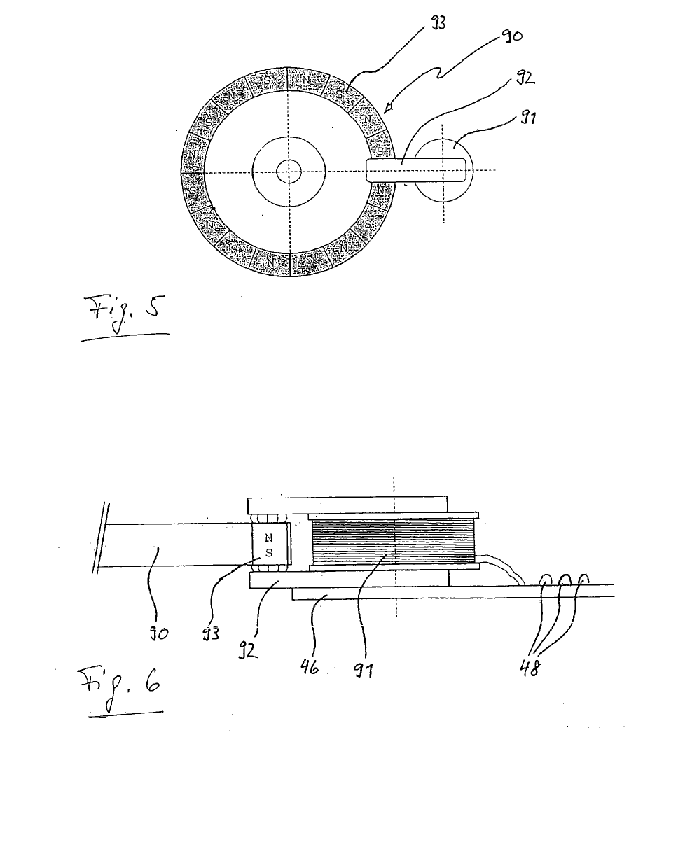

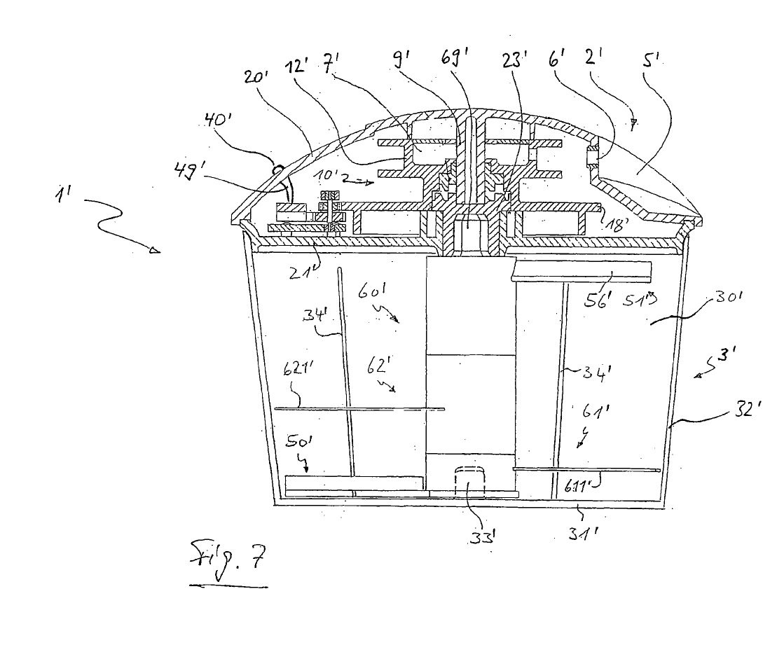

The generator unit with the generator 45 and the magnetic ring 90 is represented in a view from above, and its mounting on the base plate 46 as well, in FIGS. 5 and 6. The one-piece magnetic ring 90, which is fixed on the rotor disk 18 of the secondary drive unit, is divided into an even number of sectors 93 on its circumference. In this case the sectors 13 have been alternatingly magnetized on their surface in accordance with magnetic North N, or respectively magnetic South S. This magnetic ring 90 is now guided in a contactless manner by a stator 92 of the generator 45. The alternating magnetic field generated in this way generates an ac-voltage, which is rectified in the electronic unit 47 and is sufficient for further electrical current supply of the electronic unit 47, as well as of the light-emitting diodes 48.

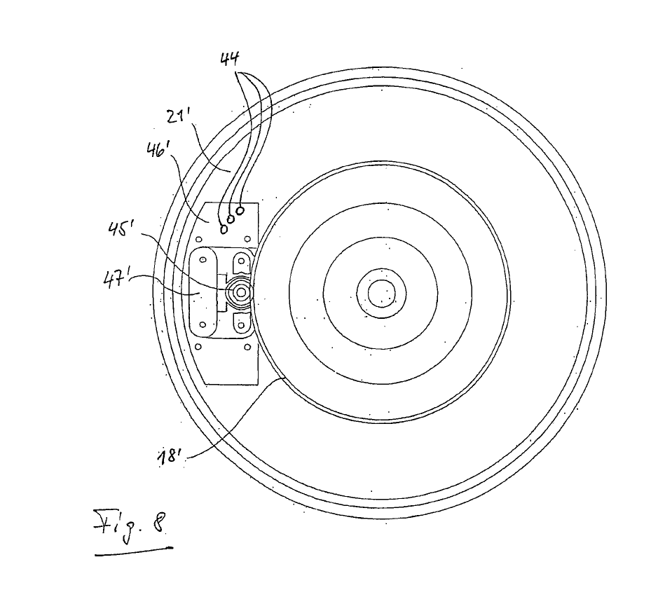

FIGS. 7 and 8 show another embodiment of a device 1 with a one-piece drive mechanism 10′ with a further embodiment of the generator 45′. A generator wheel is connected by means of a positive or non-positive connection, which can for example be provided by means of gear wheels or rubber wheels, with a rotor disk 18′ of the drive mechanism. Here, the rotor disk 18′ is directly connected with the winder/cord roller 12′, so that electrical current is generated in the course of a processing step, as well as during reverse rotation caused by the spring.

One skilled in the art will realize that the generator 45 in the above described exemplary embodiment with the two-piece drive mechanism 10 can also be driven by means of the primary, as well as by means of the secondary drive unit.

The technical teaching in regard to the processing degree indicator can also be advantageously transferred to other manually operated kitchen utensils in which a desired degree of processing is correlated with a defined number of processing steps, preferably with revolutions of a drive or processing unit.

Preferably, all further components of the device, with the exclusion of the blades 611, 621, 631, the magnetic ring, the LEDs and the electronic unit, in particular all accessible surfaces and all surfaces which come into contact with foodstuffs, as well as the essential parts of the drive mechanism 10, are made from plastics, such as SAN (styrene acrylonitrile), POM (polyoxy-methyline) and ABS (acrylonitrile butadiene styrene), by an extrusion process. In particular those parts which come into contact with the foodstuffs to be processed, are approved for use with foodstuffs.

In preferred types of embodiment of the devices 1 in accordance with the instant invention, the diameter of the container 30 for the material to be cut lies between 120 and 140 mm at a height of 70 to 90 mm. The magnetic ring 90 is divided into 12 to 16 sectors 93, and the coil body 91 of the stator 92 consists of 2,000 to 4,000, preferably 3,000 wire coils. An appropriate capacitive storage device is employed for the intermediate storage of the voltage.

In place of blades, finger-shaped processing means are for example employed for peeling onions and/or garlic, such as are known from devices in accordance with the species. Processing means for cutting and for squeezing are combined with each other in one unit for processing of soft or pre-cooked vegetables and/or fruit, in particular for preparing food for small children and babies.

The devices in accordance with the invention can be employed in many ways in the kitchen or household by means of further inserts which are arranged in the lower part 3 in place of the cutting unit 60 and can be put into rotation by means of the drive mechanism 10, for example by means of a basket for centrifuging herbs, an S-shaped mixing arm, or a beater for frothing milk.

The processing container 30 for material to be cut which, in embodiments described up to now, had been shown to be substantially rotationally round and with its diameter slightly tapering downward, can also be simply exchanged and adapted to the respective purpose of use. The container 30 for the material to be processed with the finished processed material can be closed off by a separate cover and stored. To this end the cutting unit 60 or other processing insert is removed. With a second container 30 for material to be cut, the device in accordance with the invention is again ready for use.

In accordance with a further embodiment of the invention, not represented in the drawings, the drive unit is housed in a device base, and the processing container with the processing means and a cover on the top are placed on this device basis. Driving can again take place by means of a cord pull or other suitable manual drive mechanism. The display unit is arranged on the device in such a way that it is easily visible to the user during the operation of the device.

### LIST OF REFERENCE NUMERALS

1, 1′ Device
2, 2′ Top part
3, 3′ Lower part
4 Central shaft
5, 5′ Recess for handle
6, 6′ Feed-through opening
7, 7′ Spring housing
8 Cover shaft
9, 9′ Bearing journal
10, 10′ Drive mechanism
11 Handle
12, 12′ Winder/cord roll
14 Hollow wheel/drive wheel
17 Axial journal
18, 18′ Rotor disk
19 Bearing bushing
20 Cover
21, 21′ Base
23, 23′ Engagement member
29 Bottom base
30, 30′ Processing container
31, 31′ Bottom
32, 32′ Lateral wall
33, 33′ Bearing journal
34, 34′ Swirling rib
40′, 40′ Display unit
45 Generator
46, 46′ Base plate
47, 47′ Electronic unit
48, 44 Light-emitting diode/light-emitting diodes
48′ Light spots
49, 49′ Optical wave guide
50, 50′ Lower deflector
51, 51′ Upper deflector
56, 56′ Deflection wing
60, 60′ Cutting unit
61, 61′ First cutter
611, 611′ First blade
62, 62′ Second cutter, first movable cutter
621, 621′ Second blade
63 Third cutter
631 Third blade
67 Cutter shaft
69 Drive cam
70 Pull cord
71 Reception opening
72 Restoring spring
80 Clamping ring
90 Magnetic ring
91 Coil body
92 Stator
93 Sectors
190 Flange
191 Axial cylinder
192 Hold-down device
193 Bearing sleeve

1. A device for processing foodstuffs, comprising a top part, a drive mechanism, a lower part with a processing container and a processing unit, which is manually driven and put into a rotating motion by means of the drive mechanism, wherein the device includes a processing degree indicator.

2. The device in accordance with claim 1, wherein the processing degree indicator includes a display unit, which is visible to the user.

3. The device in accordance with one of claims 1 wherein processing degree indicator is an electric/electronic processing degree indicator.

4. The device in accordance with claim 3, wherein the device includes a generator unit with a generator for generating the electrical energy for the processing degree indicator.

5. The device in accordance with claim 4, wherein the generator is connected by means of a frictional or positive connection with the drive mechanism.

6. The device in accordance with claim 4, wherein the generator comprises a magnetic ring, which is arranged on a driven portion of the drive mechanism.

7. The device in accordance with claim 3, wherein the display unit is illuminated by means of at least one light-emitting diode.

8. The device in accordance with claim 7, wherein at least one light-emitting diode is arranged directly on the base plate and is operatively connected with the display unit by means of at least one optical wave guide.

9. The device in accordance with claim 3, wherein the processing degree indicator includes a counter.

10. A method for indicating a processing degree of a manually operable device for processing foodstuffs, wherein the number of processing steps of a processing unit is detected indirectly or directly by means of a counter, and an information regarding the detected number is signaled to a user numerically or by category.
